(19) United States
(12) Patent Application Publication
(10) Pub. No.: US 2012/0274304 A1
(43) Pub. Date: Nov. 1, 2012

(54) Low-Voltage-Driven Boost Circuit and Associated Method

(75) Inventors: Song-Yi Lin, Taipei City (TW); Hsuan-I Pan, Taipei City (TW); Guo-Kiang Hung, New Taipei City (TW)

(73) Assignee: MSTAR SEMICONDUCTOR, INC., Hsinchu Hsien (TW)

(21) Appl. No.: 13/301,891

(22) Filed: Nov. 22, 2011

(30) Foreign Application Priority Data
Apr. 26, 2011 (TW) 100114515

(51) Int. Cl. G05F 3/08

(52) U.S. Cl. 323/311

(57) ABSTRACT

A low-voltage-driven boost circuit is provided. The boost circuit includes an inductor, a diode, a capacitor, a first switch and a second switch. The second switch is coupled between the first switch and an anode of the diode. The first switch selectively conducts according to a switch signal, and the second switch conducts as the first switch conducts.

This application claims the benefit of Taiwan application Serial No. 100114515, filed Apr. 26, 2011, the subject matter of which is incorporated herein by reference.

### BACKGROUND OF THE INVENTION

1. Field of the Invention

The invention relates in general to a low-voltage-driven boost circuit and associated method, and more particularly to a low-voltage-driven boost circuit comprising spliced switch transistors that are controlled with low-voltage switch signals and associated method.

2. Description of the Related Art

FIG. 1 shows a conventional boost circuit 10. The boost circuit 10, for boosting a lower direct-current voltage Vi to a higher direct-current voltage Vo at a node nd4, comprises an inductor L0, a diode D0, a transistor M0 and a capacitor C0. The transistor M0 is a switch transistor, which has its gate controlled by a switch signal sw1 and selectively conducts between a node nd3 and a ground voltage GND according to the switch signal sw1. FIG. 1 also illustrates a waveform timing diagram of the switch signal sw1, with a horizontal axis representing the time and a vertical axis representing a voltage of the signal. The switch signal sw1 periodically controls the transistor M0 according to a period T. Within each period T, the switch signal sw1 triggers the transistor M0 to conduct by a voltage Vi0, and deactivates the transistor M0 by the ground voltage GND at the remaining period.

When the transistor M0 is conducted, the node nd3 is conducted to the ground voltage VND, and the voltage Vi induces magnetic energy into the inductor L0. When the switch signal sw1 deactivates the transistor M0, the magnetic energy in the inductor L0 is released to the capacitor C0 via the forward conducted diode D0 to support the voltage Vo at the node nd4, such that the voltage Vo is greater than the voltage Vi. A ratio between the voltage Vo and the voltage Vi may be controlled by a ratio between a period Ton and the period T (i.e., duty cycle). The control voltage Vo gets larger as a length of the period Ton approaches that of the period T. For example, for a voltage Vi of 12V, it is possible to generate a voltage Vo of 60V by appropriately controlling the duty cycle of the switch signal sw1.

When the transistor M0 is inactive, the voltage at the node nd3 is a sum of a cross voltage of the diode D0 and the voltage Vo, such that the drain voltage of the transistor M0 is greater than the voltage Vo. At this point, both the drain voltage and gate voltage are equal to the ground voltage GND, and so the terminals of the transistor M0 bear rather large voltage differences. Therefore, it is essential that the transistor M0 be a high voltage rated, high voltage tolerable transistor. However, a threshold voltage of the high voltage rate transistor M0 is accordingly higher in order to drive the transistor M0. In response to the high threshold voltage of the transistor M0, the switch signal sw1 during the period Ton also needs to provide a higher voltage Vi0 sufficient for conducting the transistor M0. For example, for an application where the voltages Vi and Vo respectively being 12V and 60V, the threshold voltage of the transistor M0 is 5V or higher.

The boost circuit 10 cooperates with a control chip 14 to control a size of the voltage Vo. The control chip 14 adjusts the duty cycle (and a frequency) of the switch signal sw1 to control the voltage Vo. However, since the voltage Vi0 required by the switch signal sw1 exceeds an output signal voltage supported by the chip 14, the chip 14 becomes incapable of directly controlling the boost circuit 10. In a switch signal sw0 output by the control chip, a size of the switch signal sw0 varies between voltages VH and GND, meaning that the switch signal sw0 is insufficient to conduct the transistor since the voltage VH is not above the threshold voltage of the transistor M0.

In view of the above, the conventional boost circuit 10 needs to cooperate with a level shifter 12. The level shifter 12, comprising resistors Rp1, Rp2 and Rp3 and transistors Q1, Q2 and Q3, operates between the voltage Vi0 and the ground voltage GND to convert the low voltage switch signal sw0 at a node nd1 to the high voltage switch signal sw1 at a node nd2. Through the level shifter 12, the switch signal sw1 is enabled to conduct the transistor M0 using the higher voltage Vi0 (higher than the voltage VH). For example, the threshold voltage of the transistor M0 is increased to above 5V in order to provide the voltage Vo with an adequate rating in a 60V application, and yet the voltage VH being only 3V in the switch signal sw0 output from the chip 14 is still insufficient to directly drive the transistor M0. Therefore, the level shifter 12 is implemented in the prior art to boost the voltage Vi0 of the switch signal sw1 to 12V.

However, due to the provision of the level shifter 12 required by the boost circuit 120, the boost technique illustrated in FIG. 1 needs additional circuit elements that occupy a greater circuit area as well as increasing a cost of the conventional boost technique. Further, a response time is lengthened as a result of resistor and capacitor delay effects caused by the additional circuit elements. For example, when the switch signal sw0 is input into the level shifter 12, delay is incurred at rising and falling edges of pulses of the switch signal sw1 generated at the output end that undesirably affects the response time of the switch signal sw1, such that the switch signal sw1 cannot spontaneously switch between the voltages Vi0 and GND. Consequently, reduction in the cycle T cannot be implemented such that the frequency of the switch signal sw1 cannot be increased.

In the boost technique implementing a capacitor and a switch transistor, high frequency switching performed by driving the switch transistor with a high frequency switch signal offers many advantages. For example, a size of the capacitor as well as EMI is reduced, and energy utilization efficiency is elevated. However, the conventional boost technique illustrated in FIG. 1 is inapplicable to high frequency switching. A preferred switch signal frequency is in the megahertz range, whereas the switch signal frequency in the solution associated with the prior art in FIG. 1 can only reach tens of kilohertz.

Further, when the transistor M0 switches between being conducted and inactive, the voltage change at the node nd3 is unfavorable for high frequency switching. As shown in FIG. 1, between the gate and the drain of the transistor is a parasitic capacitance represented by capacitor Cgd. When the transistor M0 is conducted, the voltages at the nodes nd2 and nd3 at the two ends of the capacitor Cgd are respectively Vi0 and GND. When the transistor M0 is inactive, the voltage at the node nd2 changes to GND, and the voltage at the node nd3 changes to exceed the voltage Vo. For example, supposing the voltage Vo is 60V, the voltage at the node 3 is to escalate from the ground voltage GND of 0V to over 60V when the transistor M0 switches from being conducted to inactive. That is, when the transistor switches its state, a voltage difference between the nodes nd2 and nd3 is extremely drastic, and such drastic change is only accomplished by a lengthy charging/discharging process of the capacitor Cgd with the switch signal sw1 in order to successfully drive the transistor M0—this difficulty is one of the reasons that the conventional boost technique fails to achieve high frequency switching.

### SUMMARY OF THE INVENTION

The invention is directed to a boost circuit and associated method for overcoming drawbacks of the prior art, so as to realize a boost technique that has a simplified circuit structure and is capable of high frequency switching.

According to an aspect of the present invention, a low-voltage-driven boost circuit is provided. The boost circuit comprises an inductor, a diode, a capacitor, a first switch and a second switch. The inductor is coupled between a first voltage and a first node, the diode has an anode and a cathode respectively coupled to the first node and the second node, and the capacitor is coupled to the second node. The first switch comprises a first transistor, which has a first drain, a first source and a first gate respectively coupled to a first channel end, a second channel end and a first control end of the first switch. The first control end is coupled to a switch signal, and the first switch selectively conducts between the first channel end and the second channel end according to the switch signal. The second switch comprises a second transistor, which has a second drain, a second source and a second gate respectively coupled to a third channel end, a fourth channel end and a second control end of the second switch. The third channel end, the fourth channel end and the second control end are respectively coupled to the first node, the first channel end and a second voltage. When the first switch conducts between the first channel end and the second channel end, the second switch conducts between the third channel end and the fourth channel end; when the first switch stops conducting between the first channel end and the second channel end, the second switch also stops conducting between the third channel end and the fourth channel end.

For example, the second voltage is a direct-current voltage and equals the first voltage. When a cross voltage between the first gate and the first source is greater than a first threshold voltage, the first transistor conducts between the first drain and the first source. When a cross voltage between the second gate and the second source is greater than a second threshold voltage, the second transistor conducts between the second drain and the second source. When the first switch stops conducting between the first channel end and the second channel end, the second switch causes the voltage at the second channel end to be smaller than the second voltage. Therefore, the first transistor may be a transistor with a low rated voltage and a low threshold voltage. That is, the first threshold voltage may be smaller than the second threshold voltage. Thus, the first transistor may be directly controlled by a low voltage switch signal of a control chip.

To adapt to the control chip, the boost circuit may be additionally provided with a voltage detection circuit and/or a current detection circuit. The voltage detection circuit provides a voltage detection signal at a voltage dividing node according to a voltage at the second node. For example, the voltage detection circuit comprises a first resistor and a second resistor. The first resistor is coupled between the second node and the voltage dividing node, and the second resistor is coupled between the voltage dividing node and a ground voltage. The current detection circuit is coupled to the first switch, and provides a current detection signal according to a current at the second channel end. For example, the current detection circuit comprises a resistor, and is coupled between the second channel end and a ground voltage, such that a size of the current at the second channel end is associated with the voltage at the second channel end, and the voltage at the second channel end may serve as a current detection signal. The voltage detection signal and the current detection signals are transmitted to the control chip, which then accordingly adjust the timing (e.g., duty cycle and/or frequency) of the switch signal to feedback the output voltage at the second node of the boost circuit.

According to another aspect of the present invention, a method for controlling/driving a boost circuit with a low voltage is provided. The boost circuit receives a first voltage to provide an output voltage, and comprises a second transistor having a second gate and a second source. The method comprises: providing a first transistor comprising a first gate and a first drain, the first drain being coupled to the second source; providing a low voltage signal to the first gate to selectively conduct the first transistor; causing the output voltage to surpass the first voltage when the switch signal deactivates the first transistor and the second transistor; and coupling the second gate to a second voltage, the second voltage being a direct-current voltage or being equal to the first voltage. To perform feedback control, a voltage detection circuit is provided and coupled to a second node at which the boost circuit provides the output voltage to provide a voltage detection signal according to the output voltage, and the voltage detection signal is received by the chip. Further/alternatively, a current detection circuit is provided and coupled to a first transistor to provide a current detection signal according to a current at a first drain, and the current detection signal is received by the chip.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1. is a schematic diagram of a conventional boost circuit.

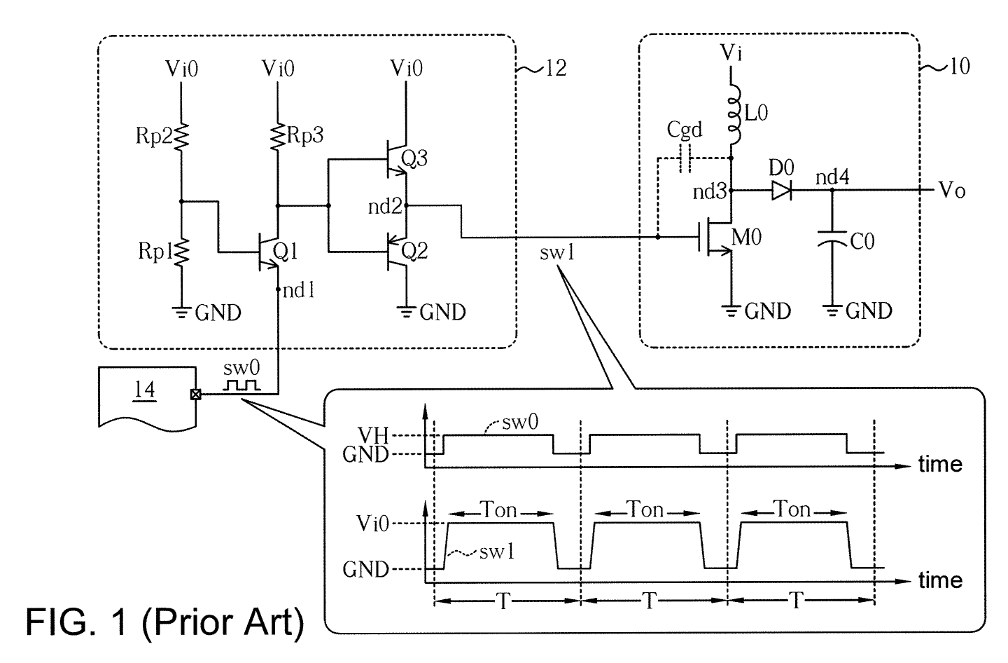

FIG. 2 is a schematic diagram of a boost circuit according to an embodiment of the present invention.

FIG. 3 is a schematic diagram of a boost circuit according to another embodiment of the present invention.

### DETAILED DESCRIPTION OF THE INVENTION

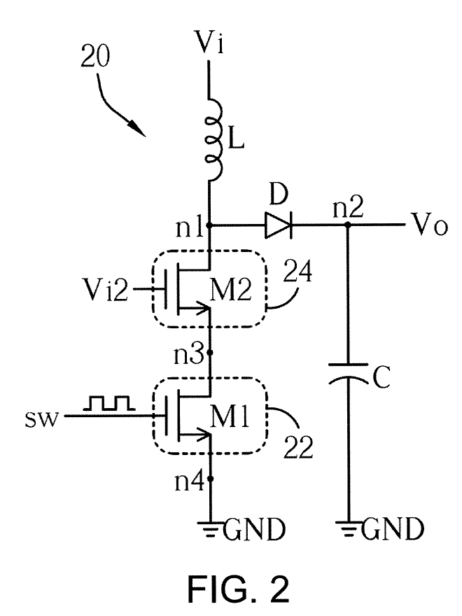

FIG. 2 shows a schematic diagram of a boost circuit 20 according to an embodiment of the present invention. The boost circuit 20 draws a voltage Vi and provides an output voltage Vo at a node n2. The boost circuit 20 comprises an inductor L, a diode D, a capacitor C, and two switches 22 and 24.

In the boost circuit 20, the inductor L is coupled between the voltage Vi and a node n1. The diode may be a Schottky diode, and has its anode and cathode respectively coupled to the nodes n1 and n2. The capacitor C is coupled between the node n2 and a ground voltage GND. The switch 22 may be realized by a transistor M1. For example, the transistor M1 is an n-channel metal oxide semiconductor (NMOS), which has drain, source and gate serving as two channel ends and a control end of the switch 22 respectively. The two channel ends and the control end of the switch 22 are respectively coupled to nodes n3, n4 and a switch circuit sw, so as to selectively conduct the switch 22 between the nodes n3 and n4 according to the switch signal sw. The other switch 24 may be realized by a transistor M2. For example, the transistor M2 is an NMOS, which has its drain, source and gate serving as two channel ends and a control end of the switch 24. The two channel ends and the control end of the switch 22 are respectively coupled to the nodes n1, n3 and a voltage Vi2. For example, the voltage Vi2 is a direct-current voltage; equals the voltage Vi in an embodiment.

In an embodiment, the transistor M1 is a transistor having a lower rated voltage, a smaller size and a lower threshold voltage; the transistor M2 is a transistor having a higher rated voltage and a higher threshold voltage. The transistor M1 may be controlled to conduct by directly utilizing a low voltage switch signal for that it has a lower threshold voltage.

Operations of the boost circuit 20 are to be described below. The transistor M1 is controlled by the switch signal sw. When the switch signal sw triggers the transistor M1 to conduct, the transistor M1 conducts the node n3 to the ground voltage GND at the node n4. For the transistor M2, the voltage at its drain at the node n3 is conducted to the ground voltage GND, and the voltage at its gate is maintained at the voltage Vi2, such that a cross voltage between its gate and source is sufficient to surpass the threshold voltage of the transistor M2. Thus, the transistor M2 also conducts as the transistor M1 conducts to couple the node n1 to the ground voltage GND, so as to allow the voltage Vi to charge the inductor L with magnetic energy.

When the switch signal sw deactivates the transistor M1, the node n3 is no longer coupled to the ground voltage GND. The transistor M2 charges the node n3 to increase the voltage at the node n3. Along with the increase of the voltage at the node n3, the cross voltage between the gate and the source of the transistor M2 gradually drops. When the cross voltage between the gate and source of the transistor M2 is smaller than the threshold voltage of the transistor M2, the transistor M2 stops conducting to become inactive. Thus, the magnetic energy in the inductor L is released via the diode D, so as to support the voltage Vo at the node n2 to boost the voltage.

In an embodiment, the voltage Vi and Vi2 may be 12V. To accommodate settings of the duty cycle of the switch signal sw, the voltage Vo may be as high as 60V. Therefore, the transistor M2 may be a power transistor with a high rated voltage sufficient to withstand the high voltage of the node n1. For the transistor M2, when the transistor M1 conducts the node n3 to the ground voltage GND, the voltage Vi2 at the gate of the transistor M2 is sufficient to surpass the threshold voltage (e.g., 5V) of the transistor M2 to successfully conduct the transistor M2.

Further, when the transistor M1 is arranged serially next to the source of the transistor M2, the drain of the transistor M1 at the node 3 need not withstand the high voltage Vo. When the transistor M2 and M1 are not conducted, the voltage at the node n3 is lower than the voltage Vi2 (e.g., 12V), so that the transistor M1 is not necessarily a power transistor with a high rated voltage. The transistor M1 may be a transistor with a small size, a low rated voltage and hence a lower threshold voltage. Since the threshold voltage of the transistor M1 is low, the transistor M1 may be directly conducted or deactivated by the low voltage switch signal sw. For example, the switch signal sw is a signal directly output by the control chip, and switches between 0V and 3V. Thus, the control chip is capable of directly controlling boost operations through a combination of the low voltage driven transistor M1 and the high voltage driven transistor M2 in the replacement of circuits including the level shifter implemented in the prior art.

Because the boost technique of the present invention does not require the level shifter utilized in the prior art, the boost circuit 20 is applicable to high frequency switching to provide advantages of the high frequency switching. Further, the circuit structure of the boost circuit of the present invention also facilitates the realization of high frequency switching. When the transistor M1 switches from being conducted to inactive, the voltage at its drain at the node 3 is under the voltage Vi2 (e.g., 12V) that is also far less than the voltage Vo (e.g., 60V). That is, when the transistor M1 switches between being conducted (activated) and deactivated, the voltage at its drain varies by a small range. For the transistor M1, a Miller effect of parasitic capacitance at its gate and drain is reduced. Therefore, the switch sw is allowed to quickly complete necessary charging/discharging on the parasitic capacitance at the gate and drain of the transistor M1, so that the transistor M1 quickly switches between being conducted and deactivated to realize high frequency boost.

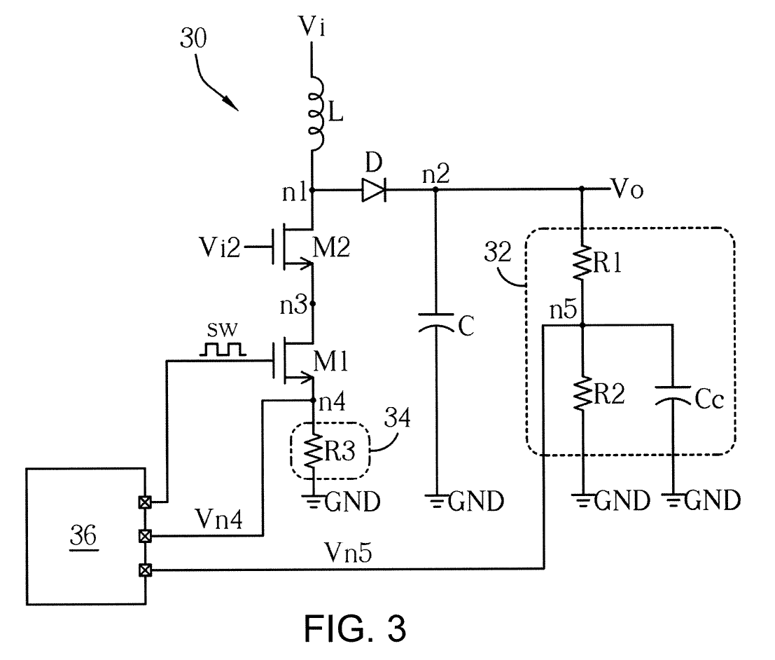

FIG. 3 shows a schematic diagram of a boost circuit 30 according to another embodiment of the present invention. The boost circuit 30 is directly controlled by a chip 36, which is a control chip or a driving chip. Similar to the boost circuit 20 in FIG. 2, the boost circuit 30 comprises an inductor L, a diode D, a capacitor C, and transistors M1 and M2 serving as switches for drawing a voltage Vi to provide an output voltage Vo. Boost principles of the boost circuit 30 are similar to those of the boost circuit 20 and shall not be again described for brevity.

As shown in FIG. 3, the boost circuit 30 is directly controlled by a switch signal sw outputted by the chip 36. To adapt to the control of the chip 36 with respect to boost operations, the boost circuit 30 is provided with a voltage detection circuit 32 and a current detection circuit 34. The voltage detection circuit 32 provides a voltage detection signal according to the voltage Vo to reflect a size of the voltage Vo. In the embodiment in FIG. 3, the voltage detection circuit 32 comprises two resistors R1 and R2 and a capacitor Cc. The resistor R1 is coupled between nodes n2 and n5, the resistor R2 is coupled between a node n5 and a ground voltage GND, and the capacitor Cc is also coupled between the node n5 and the ground voltage GND. The node n5 between the resistors R1 and R2 may be regarded as a voltage dividing node that divides the voltage Vo, such that a voltage Vn5 at the node n5 may serve as a voltage detection signal to reflect a size of the voltage Vo. The voltage Vn5 is transmitted to the chip to be utilized as reference for feedback control, and the capacitor Cc may be utilized for maintaining a stability of the feedback system.

The current detection circuit 34 is coupled to the transistor M1, and provides a current detection signal according to a current of the transistor M1. In the embodiment in FIG. 3, the current detection circuit 34 comprises a resistor R3 coupled between a node n4 and the ground voltage GND, so that a size of the current of the transistor M1 is associated with a voltage Vn4 at the node n4 and the voltage Vn4 may serve as a current detection signal. The voltage Vn4 is transmitted to the chip 36 to be utilized as another reference for feedback control.

According to the voltage detection signal and the current detection signal respectively provided by the voltages Vn5 and Vn4, the chip 36 adjusts a timing (e.g., a duty cycle and/or frequency) of the switch signal sw to feedback control the boost operations (e.g., a size of the voltage Vo) of the boost circuit 30.

With description of the embodiments, it is illustrated that the boost circuit with a spliced structure of two transistors of the present invention, compared to the conventional boost circuit and boost technique, is capable of directly being controlled by the switch signal of the chip, so that not only a cost of the boost operation and a circuit size are reduced but also a boost switch frequency is increased to realize high frequency switching. The boost technique of the present invention is suitable for all high voltage applications, e.g., an LED string for driving a display panel.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A low-voltage-driven boost circuit, comprising:
an inductor, coupled between a first voltage and a first node;
a diode, comprising an anode and a cathode, the anode being coupled to the first node, the cathode being coupled to a second node;
a capacitor, coupled to the second node;
a first switch, comprising a first channel end, a second channel end and a first control end, the first control end being coupled to a switch signal and selectively conducting between the first channel end and the second channel end according to the switch signal; and
a second switch, comprising a third channel end, a fourth channel end and a second control end respectively being coupled to the first node, the first channel end and a second voltage;
wherein, when the first switch conducts between the first channel end and the second channel end, the second switch conducts between the third channel end and the fourth channel end, and when the first switch stops conducting between the first channel end and the second channel end, the second switch stops conducting between the third channel end and the fourth channel end.

2. The boost circuit according to claim 1, wherein the second voltage is a direct-current voltage.

3. The boost circuit according to claim 1, wherein the second voltage equals the first voltage.

4. The boost circuit according to claim 1, wherein the first switch comprises a first transistor comprising a first drain, a first source and a first gate respectively coupled to the first channel end, the second channel end and the first control end, when a cross voltage between the first gate and the first source is greater than a first threshold voltage, the first transistor conducts between the first drain and the first source; the second switch comprises a second transistor comprising a second drain, a second source and a second gate respectively coupled to the third channel end, the fourth channel end and the second control end, and when a cross voltage between the second gate and the second source is greater than a second threshold voltage, the second transistor conducts between the second drain and the second source; and the first threshold voltage is smaller than the second threshold voltage.

5. The boost circuit according to claim 1, wherein when the first switch stops conducting between the first channel end and the second channel end, the second switch causes a voltage of the first channel end to be smaller than the second voltage.

6. The boost circuit according to claim 1, further comprising:
a voltage detection circuit, for providing a voltage detection signal at a voltage dividing node according to a voltage at the second node.

7. The boost circuit according to claim 6, wherein the voltage detection circuit comprises a first resistor and a second resistor, the first resistor being coupled between the second node and the voltage dividing node, and the second resistor being coupled between the voltage dividing node and a ground voltage.

8. The boost circuit according to claim 1, further comprising:
a current detection circuit, coupled to the first switch, for providing a current detection signal according to a current at the second channel end.

9. The boost circuit according to claim 8, wherein the current detection circuit comprises a resistor coupled between the second channel end and a ground voltage.

10. A method for driving a boost circuit with a low voltage, the boost circuit receiving a first voltage to provide an output voltage and comprising a second transistor, the second transistor comprising a second gate and a second source, the method comprising:
providing a first transistor comprising a first gate and a first drain, the first drain being coupled to the second source; and
providing a low voltage switch signal to the first gate for selectively activating the first transistor, and causing the output voltage to surpass the first voltage when the low voltage switch signal inactivates the first transistor and the second transistor.

11. The method according to claim 10, wherein the low voltage switch signal is provided by a chip.

12. The method according to claim 10, further comprising:
coupling the second gate to a second voltage.

13. The method according to claim 12, wherein the second voltage equals the first voltage.

14. The method according to claim 12, wherein the second voltage is a direct-current voltage.

15. The method according to claim 11, the boost circuit providing the output voltage at a second node, the method further comprising:
providing a voltage detection circuit, the voltage detection circuit being coupled between the second node, for providing a voltage detection signal according to the output voltage; and
receiving the voltage detection signal by the chip.

16. The method according to claim 11, further comprising:
providing a current detection circuit, the current detection circuit being coupled to the first transistor, for providing a current detection signal according to a current of the first drain; and
receiving the current detection signal by the chip.
